(19) United States
(12) Patent Application Publication
(10) Pub. No.: US 2024/0423876 A1
(43) Pub. Date: Dec. 26, 2024

(54) Pacifier and Method for Manufacturing It

(71) Applicant: FB Group ApS, Hinnerup (DK)

(72) Inventor: Henrik Tøth Jensen, Søften Hinnerup (DK)

(21) Appl. No.: 18/825,048

(22) Filed: Sep. 5, 2024

Related U.S. Application Data
(63) Continuation of application No. PCT/DK2023/050030, filed on Feb. 22, 2023.

(30) Foreign Application Priority Data
Mar. 11, 2022 (DK) PA 2022 00198
May 25, 2022 (DK) PA 2022 00491

(51) Int. Cl. A61J 17/00

(52) U.S. Cl. CPC A61J 17/001; A61J 17/105

(57) ABSTRACT

A pacifier comprises a male member, a shield having a shield opening having a width (W₁), and a nipple extending through the shield opening and having a nipple opening provided in a proximal end portion. A male member extends through the nipple opening and through the shield opening. The pacifier comprises an intermediate member extending through shield opening. The intermediate member comprises a channel through which the male portion extends and engages with the intermediate member, hereby lockingly attaching the nipple to the shield. The width (W₂) of the intermediate member is larger than the width (W₁) of the shield opening.

### CROSS-REFERENCE TO RELATED APPLICATIONS

This application is a continuation under 35 U.S.C. 111 of International Patent Application No. PCT/DK2023/050030, filed Feb. 22, 2023, which claims the benefit of and priority to Danish Application Nos. PA 2022 00198, filed Mar. 11, 2022, and PA 2022 00491, filed May 25, 2022, each of which is hereby incorporated by reference in its entirety.

### FIELD OF INVENTION

The present invention relates in general to pacifiers and, more particularly, to pacifiers which include a nipple made from silicone, latex or another elastomer. The present invention also relates to a method for manufacturing such pacifiers.

### BACKGROUND

Pacifiers which incorporate a nipple formed from an elastomeric material are well known and have been used for many years. Several of these pacifiers include a pacifying nipple to service the pacifying needs of an infant. A typical prior art pacifier comprises a rubber nipple protruding from a centrally arranged opening in a shield. Often a ring handle is attached to a cap covering the rear end of the nipple protruding from the rear end of the shield.

Rubber is a dying material which starts to change from the very moment it is produced. The process of damage to the rubber will, however, increase by stress, pressure, and changes in temperature and by exposure to ultraviolet (UV) light. Accordingly, the density, color, hardness and texture of rubber will typically change over time due to the ambient conditions. Silicone, however, is not affected by UV light or extreme temperatures in the same manner as rubber. Moreover, eventual failure of silicone will typically result in simple tears, providing a clear indication that the silicone needs replacing without causing any long-term contamination.

A typical prior art pacifier is produced by inserting a nipple through an opening in the central opening of the shield. The nipple is kept in place by a male member that has been lockingly inserted into the channel of the proximal end of the nipple, which nipple extends through the central opening of the shield and protrudes therefrom. During this mounting procedure large compressive radially directed forces are applied towards the nipple. When mounting a rubber nipple these forces typically do not permanently damage the wall structure of the nipple. When mounting a silicone nipple in this way, however, the forces applied create permanent damage to the wall structure of the nipple. Accordingly, the silicone nipples tend to tear.

Therefore, no commercially available pacifiers have a nipple made from silicone, wherein the nipple is kept in place by a male member that has been lockingly inserted into the channel of the proximal end of the nipple that extends through the central opening of the shield and protrudes therefrom.

DE29603722U1 discloses a pacifier comprising a male member, a shield having a shield opening and a nipple that extends through the shield opening has a nipple opening provided in a proximal end portion. The male member extends through the nipple opening and through the shield opening. The pacifier comprises an intermediate member extending through the shield opening, wherein the intermediate member comprises a channel, through which channel the male portion extends and engages with the intermediate member. Neither the nipple nor the intermediate member is, however, restricted from being retracted from the opening in the shield. Accordingly, there is a risk that the user of the pacifier unintendedly disassembles the pacifier. Accordingly, there is a need for providing an alternative, in which this risk can be reduced or even eliminated.

### BRIEF DESCRIPTION

To increase the lifetime and robustness of the pacifier it would be desirable to provide a pacifier with a pacifying nipple made from silicone, wherein the nipple is kept in place by a male member that has been lockingly inserted into the channel of the proximal end of the nipple.

It would also be desirable to provide a method for producing a pacifier with a pacifying nipple made from silicone, wherein the nipple is kept in place by a male member that has been lockingly inserted into the channel of the proximal end of the nipple.

A pacifier according to the present disclosure is a pacifier comprising:
a male member,
a shield having a shield opening having a width W₁,
a nipple extending through the shield opening and having a nipple opening provided in a proximal end portion,
   wherein the male member extends through the nipple opening and through the shield opening,
   wherein the pacifier comprises an intermediate member extending through the shield opening, wherein the intermediate member comprises a channel, through which channel the male portion extends and engages with the intermediate member and hereby lockingly attaches the nipple to the shield, wherein the width W₂ of the intermediate member is larger than the width W₁ of the shield opening.

Hereby, less friction is generated during the mounting of the nipple (attaching the nipple to the shield). Accordingly, it is possible to provide a pacifier with a pacifying nipple made from silicone. Thus, it is possible to provide an improved pacifier having an increased lifetime and robustness.

When mounted, the male member prevents the intermediate member from being retracted from the shield opening.

The male member, the intermediate member and the shield may be made from plastic, e.g. by injection molding. The male member, the intermediate member and the shield may be made from other materials suitable for injection molding production.

In an embodiment, the intermediate member is made from a resilient member. In an embodiment, the intermediate member is made from an elastomer.

In an embodiment, the intermediate member comprises two components that are attached to each other.

In an embodiment, the intermediate member comprises two components that are not attached to each other but configured to be connected to each other hereby constituting a single component.

In an embodiment, the nipple is made from latex.

In an embodiment, the nipple is made from silicone.

In an embodiment, the nipple is made from another elastomer.

The nipple extends through the shield opening and a portion of the nipple protrudes from the front side of the shield. This portion is designed for babies to suck on for comfort.

The nipple comprises a nipple opening provided in a proximal end portion.

Accordingly, the intermediate member and the male member can be inserted through the nipple opening.

The male member extends through the nipple opening and through the shield opening.

The pacifier comprises an intermediate member extending through the nipple opening and through the shield opening.

The intermediate member comprises a channel. This channel extends and engages with the intermediate member and hereby lockingly attaches the nipple to the shield. In an embodiment, the channel is cylindrical. In an embodiment, the channel comprises a closed ring-shaped portion. In an embodiment, the channel is not closed but U-shaped.

The term “width W₂ of the intermediate member” is to be understood as the largest width of the part of the intermediate member that is arranged in or in front of the shield opening. In front of the shield opening is the area in which the nipple protrudes from the shield. Accordingly, the nipple is exposed and accessible in the area in front of the shield opening.

In an embodiment, the width W₂ of the intermediate member is from the distal end of the intermediate member.

The term “width W₁ of the shield opening” is to be understood as the smallest width corresponding to the smallest distance between opposing structures of the shield opening.

In an embodiment, the channel is provided in an end portion of the intermediate member.

In an embodiment, the male portion is arranged and configured to increase the width W₂ of the intermediate member upon insertion into the channel of the intermediate member. In this manner the male portion will endure that the width W₂ of the intermediate member is increased and maintained when the male portion extends through the channel of the intermediate member.

In an embodiment, the intermediate member comprises a cylindrical part. In an embodiment, the cylindrical part is provided with a protrusion protruding radially therefrom.

In an embodiment, the intermediate member comprises two or more spaced apart sections separated by a gap. Hereby, insertion of the intermediate member is eased because the gap provides flexibility and allows the two or more spaced apart and separated sections to be bent during insertion of the intermediate member.

In an embodiment, the intermediate member comprises a body portion and a section that comprises a protrusion protruding radially from the body portion.

In an embodiment, the protrusion is arranged and configured to lockingly engage with the shield opening hereby preventing the intermediate member from being retracted from the shield opening.

In an embodiment, the intermediate member comprises a cylindrical proximal end portion and a body portion extending therefrom. The cylindrical proximal end portion makes it possible to provide a good and practical mounting basis for the male member.

In an embodiment, the intermediate member extends through the nipple opening.

It is an advantage if the intermediate member comprises a section comprising a protrusion protruding radially from the body portion, wherein the protrusion is arranged and configured to lockingly engage with the shield opening hereby preventing the intermediate member from being retracted from the shield opening. Hereby, it is possible to provide a simple and reliable locking mechanism that allows the nipple to be permanently fixed to the shield.

In an embodiment, the intermediate member and the male member are integrated to form a single one-piece body. In an embodiment, the pacifier comprises a male member and a cap that are integrated to form a body.

In an embodiment, the distal portion of the male member is attached to the intermediate member by one or more attachment structures.

In an embodiment, the intermediate member is detachably attached to the male member by one or more attachment structures that are configured to break upon pushing the male member towards the free end of the intermediate member when the intermediate member has been inserted into the nipple opening and is attached thereto. Accordingly, the one-piece body provides a suitable alternative to the embodiment in which the intermediate member and the male member are two non-connected components.

In an embodiment, a protruding structure having a support surface is provided in the shield opening, wherein the protruding structure is arranged and configured to engage with the nipple and protrusion structures of an intermediate member. Hereby, it is possible to attach the nipple to the shield in a simple and reliable manner.

In an embodiment, the protruding structure protrudes radially inwards.

In an embodiment, the male member comprises a conical distal portion onto which a flanged portion is provided. Hereby, the male member can be lockingly attached to an intermediate member in a simple and reliable manner.

In an embodiment, an indentation is provided in the distal portion in the protrusions of the intermediate member, wherein the flanged portion lockingly engages with the indentation.

In an embodiment, the male member comprises a proximal cylindrical portion that is attached to a cap. Hereby, it is possible to provide a pacifier having a cap in an easy manner.

It may be an advantage that a handle ring is rotatably attached to the cap.

In an embodiment, the nipple comprises a flange provided in the proximal end portion. In an embodiment, the flange has a larger diameter than the shield opening.

Hereby, it is possible to use the flange as a stop member ensuring that the nipple can easily be positioned in the correct position.

In an embodiment, the nipple comprises a recessed portion provided in the proximal end portion adjacent to the flange.

In an embodiment, no recessed portion is provided in the proximal end portion adjacent to the flange.

In an embodiment, the nipple comprises a basically spherical distal portion.

In an embodiment, the nipple is a silicone nipple.

A method according to the present disclosure is a method for manufacturing a pacifier comprising:
a male member,
a shield having a shield opening,
a nipple extending through the shield opening and having a nipple opening provided in a proximal end portion,
   wherein the method comprises the step of lockingly inserting the male member through the nipple opening and the shield opening,
   wherein the method comprises the following steps:
inserting the nipple through the shield opening,
inserting an intermediate member through the nipple opening and through the shield opening,
inserting the male portion through the channel in such a manner that the male portion extends through and engages with the intermediate member and hereby lockingly attaches the nipple to the shield.

Hereby, it is possible to provide a method to produce a pacifier with a pacifying nipple made from silicone.

In an embodiment, the intermediate member comprises an end portion provided with a channel.

In an embodiment, the method comprises the step of manufacturing a pacifier having a nipple is made from silicone.

In an embodiment, the intermediate member comprises two spaced apart sections separated by a gap.

In an embodiment, the intermediate member comprises a cylindrical proximal end portion and a body portion extending therefrom.

In an embodiment, the intermediate member comprises a section comprising a protrusion protruding radially from the body portion, wherein the protrusion is arranged and configured to lockingly engage with the shield opening hereby preventing the intermediate member from being retracted from the shield opening.

In an embodiment, the method comprises the step of providing in the shield opening a protruding structure having a support surface, wherein the protruding structure is arranged and configured to engage with the nipple and protrusion structures of an intermediate member.

In an embodiment, the protruding structure protrudes radially inwards.

In an embodiment, the male member comprises a conical distal portion onto which a flanged portion is provided.

In an embodiment, an indentation is provided in the distal portion in the protrusions of the intermediate member, wherein the flanged portion lockingly engages with the indentation.

In an embodiment, the male member comprises a proximal cylindrical portion that is attached to a cap.

In an embodiment, a handle ring is rotatably attached to the cap.

In an embodiment, the nipple comprises a flange provided in the proximal end portion.

### BRIEF DESCRIPTION OF THE DRAWINGS

The devices and methods will become more fully understood from the detailed description given herein below. The accompanying drawings are given by way of illustration only, and thus, they are not limitative of the disclosed devices and methods. In the accompanying drawings:

FIG. 1A shows an exploded view of a pacifier according to an embodiment being assembled;

FIG. 1B shows the pacifier shown in FIG. 1A in another configuration;

FIG. 2A shows a perspective side view of a pacifier according to an embodiment;

FIG. 2B shows a cross-sectional view of the pacifier shown in FIG. 2A;

FIG. 3A shows a cross-sectional view of a first step of the method according to an embodiment;

FIG. 3B shows a cross-sectional view of a second step of the method according to an embodiment;

FIG. 4A shows a cross-sectional view of a third step of the method according to an embodiment;

FIG. 4B shows a cross-sectional view of a fourth step of the method according to an embodiment;

FIG. 5 shows a cross-sectional view of the pacifier shown in FIG. 4B in an assembled configuration;

FIG. 6A shows a rear view of a shield of a pacifier according to an embodiment during a step of the method according to an embodiment;

FIG. 6B shows a rear view of a shield of a pacifier according to an embodiment during another step of the method according to an embodiment;

FIG. 6C shows a rear view of a shield of a pacifier according to an embodiment during a further step of the method according to an embodiment;

FIG. 6D shows a cross-sectional view of the pacifier shown in FIG. 6C in an assembled configuration;

FIG. 7A shows an intermediate member of a pacifier according to an embodiment;

FIG. 7B shows another view of the intermediate member shown in FIG. 7A;

FIG. 7C shows another view of the intermediate member shown in FIG. 7A and FIG. 7B;

FIG. 7D shows a male member of a pacifier according to an embodiment;

FIG. 7E shows another view of the male member shown in FIG. 7D;

FIG. 7F shows another view of the male member shown in FIG. 7D and FIG. 7E;

FIG. 7G shows a handle ring of a pacifier according to an embodiment;

FIG. 7H shows another view of the handle ring shown in FIG. 7G;

FIG. 7I shows another view of the handle ring shown in FIG. 7G and FIG. 7H;

FIG. 8A shows a perspective, exploded view of a pacifier according to an embodiment;

FIG. 8B shows a close-up view of a one-piece structure constituting a male member and a cap according to an embodiment;

FIG. 8C shows an end view of the one-piece structure shown in FIG. 8B;

FIG. 9A shows an exploded cross-sectional view of a pacifier according to an embodiment; and

FIG. 9B shows the pacifier illustrated in FIG. 9A in an assembled configuration

### DETAILED DESCRIPTION

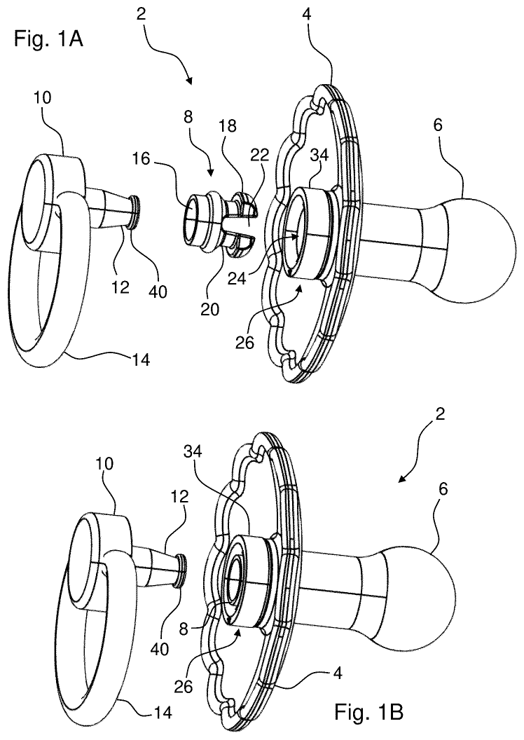

FIG. 1A illustrates an exploded view of a pacifier 2 according to an embodiment being assembled. The pacifier 2 comprises a shield 4 provided with a shield opening. In this embodiment, the shield opening is centrally arranged. In another embodiment, the shield opening may be arranged in a different position of the shield 4.

The pacifier 2 comprises a nipple 6. The nipple 6 has been inserted through the shield opening. Accordingly, the proximal end portion 26 of the nipple 6 protrudes from the rear side of the shield 4. It can be seen that the proximal end portion 26 of the nipple 6 comprises a flange 34. An opening 24 is provided in the proximal end portion 26 of the nipple 6.

In an embodiment, the nipple 6 is made of silicone. In another embodiment, the nipple 6 is made of latex. In a further embodiment, the nipple 6 is made of another elastomer.

The pacifier 2 comprises an intermediate member 8 configured to be inserted through the shield opening 24 provided in the proximal end portion 26 of the nipple 6. The intermediate member 8 comprises a body portion 20 provided with a gap that separates the body portion 20 into two separate parts. Each part comprises a protrusion 18 protruding radially from the body portion 20. The protrusions 18 are arranged and configured to lockingly engage with the shield opening, hereby preventing the intermediate member 8 from being retracted from the shield opening in order to permanently fix the nipple 6 to the shield 4.

The intermediate member 8 comprises a cylindrical end portion provided with a channel 16 arranged and configured to receive a male member 12 of the pacifier 2. The male member 12 comprises a conical distal portion onto which a flanged portion 40 is provided. The male member 12 comprises a proximal cylindrical portion that is attached to a cap 10. A handle ring 14 is rotatably attached to the cap 10.

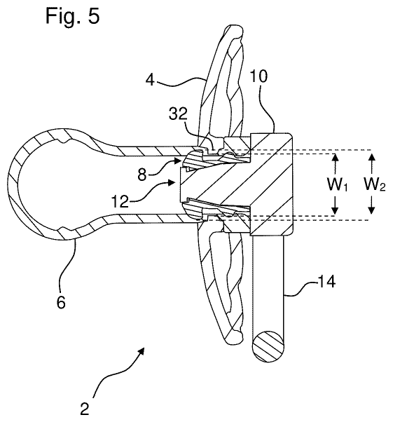

When the intermediate member 8 has been inserted into the shield opening of the shield 4, the male portion 12 is inserted into the intermediate member 8 through the channel 16. Hereby, the flanged portion 40 lockingly engages with either an indentation provided in the distal portion in the protrusions 18 of the intermediate member 8 or another structure of the pacifier 2. Accordingly, once the male member 12 has been inserted into the shield opening, the male member 12 will prevent the protrusions 18 of the intermediate member 8 from being pressed radially together. Upon insertion into the intermediate member 8, the male member 12 will press the protrusions 18 of the intermediate member 8 away from each other hereby bringing the intermediate member 8 into a locked configuration, in which the intermediate member 8 engages with the nipple 4 and a protruding structure of the shield 4 (see FIG. 5).

FIG. 1B illustrates the pacifier 2 shown in FIG. 1A in a configuration in which the intermediate member 8 has been inserted into the shield opening of the shield 4. It can be seen that the proximal end portion 26 of the nipple 6 comprises a flange 34 and that the intermediate member 8 has been inserted through the opening 24 provided in the proximal end portion 26 of the nipple 6. The intermediate member 8 has been fully inserted into the proximal end portion 26 of the nipple 6. Accordingly, the intermediate member 8 does not extend from the rear side of the nipple 6.

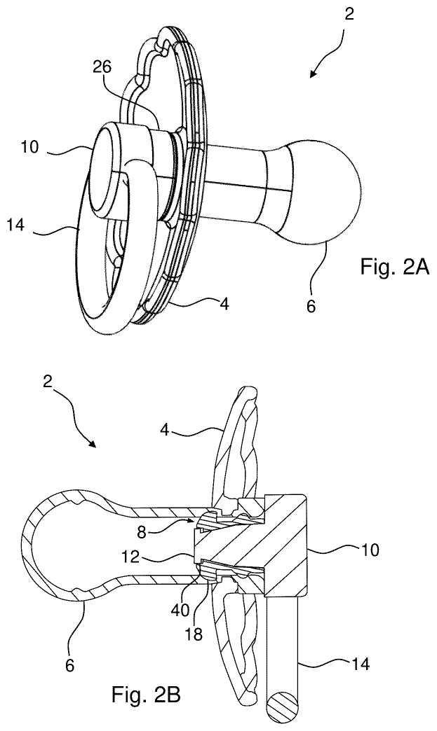

FIG. 2A illustrates a perspective side view of a pacifier 2 according to an embodiment. The pacifier 2 corresponds to the one shown in and explained with reference to FIG. 1A and FIG. 1B. The proximal end portion 26 of the nipple 6 is visible and arranged adjacent to the cap 10 of the pacifier 2. Accordingly, the proximal end portion 26 of the nipple 6 is sandwiched between the shield 4 and the cap 10. A handle ring 14 is rotatably attached to the cap 10.

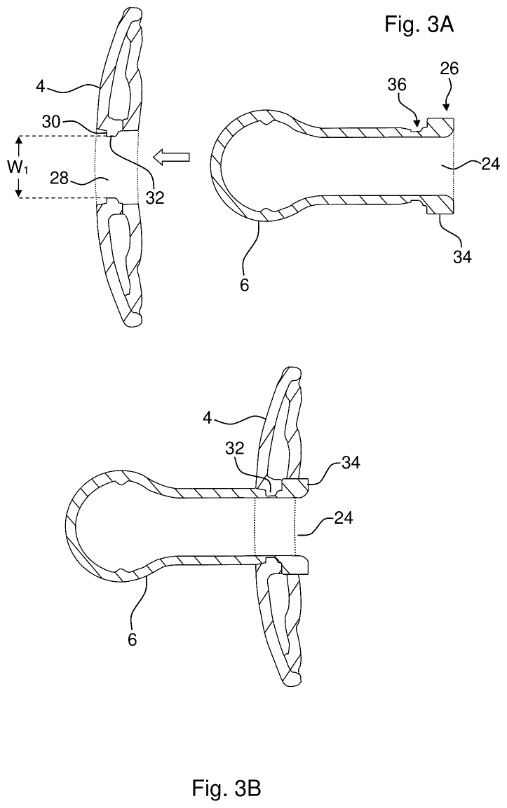

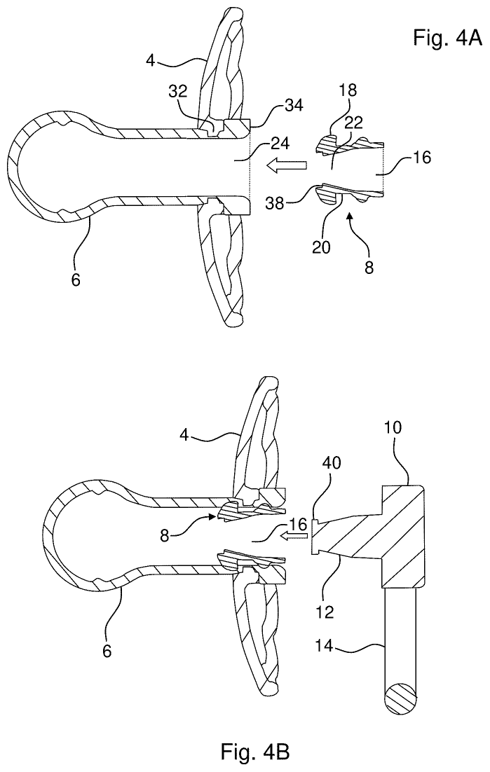

FIG. 2B illustrates a cross-sectional view of the pacifier shown in FIG. 2A. It can be seen that the flanged portion 40 of the male member 12 is brought into locking engagement with an indentation (see FIG. 4A) of the intermediate member 8 of the pacifier 2. It can be seen that the intermediate member 8 has been lockingly inserted through the shield opening of the shield 4 and that the protrusions 18 of the intermediate member 8 lockingly engage with the nipple 6 and the underlying support surface of a protruding structure (see FIG. 3A) of the shield 4.

FIG. 3A illustrates a cross-sectional view of a first step of the method according to an embodiment. In this step a nipple 6 is being inserted through a shield opening 28 provided in the shield 4. A protruding structure 32 having a support surface 30 is provided in the shield opening 28. The opening 28 has a width W₁. The protruding structure 32 is arranged and configured to engage with the nipple 6 and the protrusion structures of an intermediate member corresponding to the one shown in and explained with reference to FIG. 1A and FIG. 2B.

The nipple 6 comprises a basically spherical distal portion. An opening 24 provided in the proximal end portion 26 of the nipple 6. The nipple 6 comprises a flange 34 provided in the proximal end portion 26. A recessed portion 36 is provided in the proximal end portion 26 adjacent to the flange 34. In an embodiment, no recessed portion 36 is provided in the proximal end portion 26 adjacent to the flange 34.

FIG. 3B illustrates a cross-sectional view of a second step of the method according to an embodiment. The nipple 6 shown in FIG. 3A has been inserted through the shield opening 28 provided in the shield 4.

FIG. 4A illustrates a cross-sectional view of a third step of the method according to an embodiment. In this step an intermediate member 8 is being lockingly inserted through the shield opening 24 of a shield 4 corresponding to the one shown in FIG. 3B. It can be seen that the intermediate member 8 comprises a channel 16 and a body portion 20 comprising two sections that are separated by a gap 22. Each section comprises a protrusion 18 protruding radially from the remaining portion of the respective body portion 20.

An indentation 38 is provided in the distal portion of the intermediate member 8. The indentation 38 is arranged and configured to lockingly engage with a flanged portion provided in the distal end of the male portion shown in FIG. 4B.

FIG. 4B illustrates a cross-sectional view of a fourth step of the method according to an embodiment. In this step, the intermediate member 8 (shown in FIG. 4A) has been inserted into the shield opening 24 of the shield 4. Hereafter, the male portion 12 has to be inserted into the intermediate member 8 through the channel 16. The male member 12 corresponds to the one shown in and explained with reference to FIG. 1A, FIG. 1B, FIG. 2A and FIG. 2B.

FIG. 5 illustrates a cross-sectional view of the pacifier 2 shown in FIG. 4B in an assembled configuration. The male portion 12 has to be inserted into the intermediate member 8. Accordingly, the flanged portion 40 of the male member 12 lockingly engages with the indentation provided in the distal portion in the protrusions 18 of the intermediate member 8. Accordingly, the male member 12 will prevent the protrusions 18 of the intermediate member 8 from being pressed radially together. Upon insertion of the male member 12 into the intermediate member 8, the male member 12 will press the protrusions 18 of the intermediate member 8 away from each other hereby bringing the intermediate member 8 into a locked configuration, in which the intermediate member 8 engages with the nipple 4 and a protruding structure of the shield 4. The width W₂ of the intermediate member 8 is larger than the width W₁ of the shield opening 28 when the male portion 12 extends and engages with the intermediate member 8.

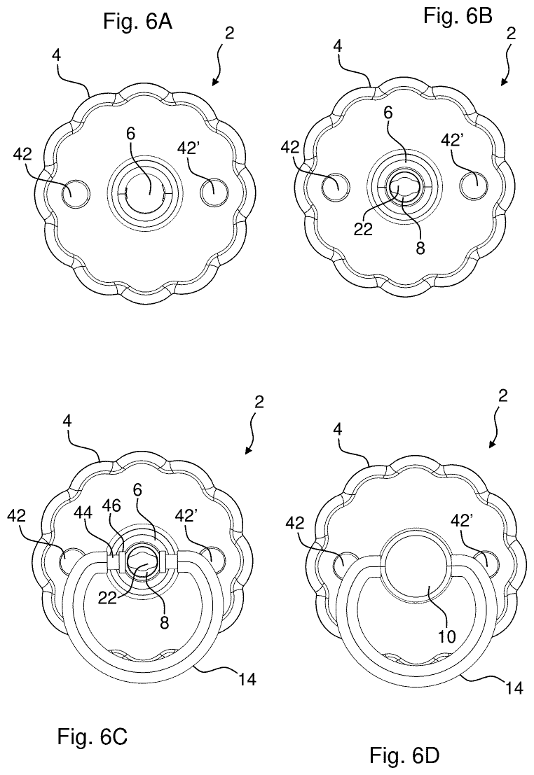

FIG. 6A illustrates a rear view of a shield 4 of a pacifier 2 according to an embodiment during a step of the method according to an embodiment. In this step a nipple 6 has been inserted through the shield opening of the shield 4. It can be seen that the shield 4 is provided with two holes 42, 42′.

FIG. 6B illustrates a rear view of a shield 4 of a pacifier 2 according to an embodiment during another step of the method according to an embodiment. In this step an intermediate member 8 has been inserted through the opening provided in the proximal end portion of the nipple 6. It can be seen that the intermediate member 8 comprises a body portion having two separate sections, wherein a gap 22 that separates the body portion 20 into two separate parts is provided between the sections.

FIG. 6C illustrates a rear view of a shield 4 of a pacifier 2 according to an embodiment during a step of the method according to an embodiment. In this step, a handle ring 14 is placed on the rear side of the shield 4. The handle ring 14 comprises an end flange 46 provided in each end. Moreover, a thinned portion 44 is provided adjacent to each end flange 46. The end flanges 46 and the thinned portions 44 are arranged and configured to engage with corresponding structures of the cap 10 (see FIG. 6D) hereby constituting two rotational joints. Hereby, the handle ring 14 can be rotatably attached to the cap 10.

FIG. 6D illustrates a cross-sectional view of the pacifier 2 shown in FIG. 6C in an assembled configuration. It can be seen that a cap 10 has been attached to the shield 4. The cap 10 comprises a male member corresponding to the one shown in and explained with reference to FIG. 1A, FIG. 1B, FIG. 2B, FIG. 4B and FIG. 5.

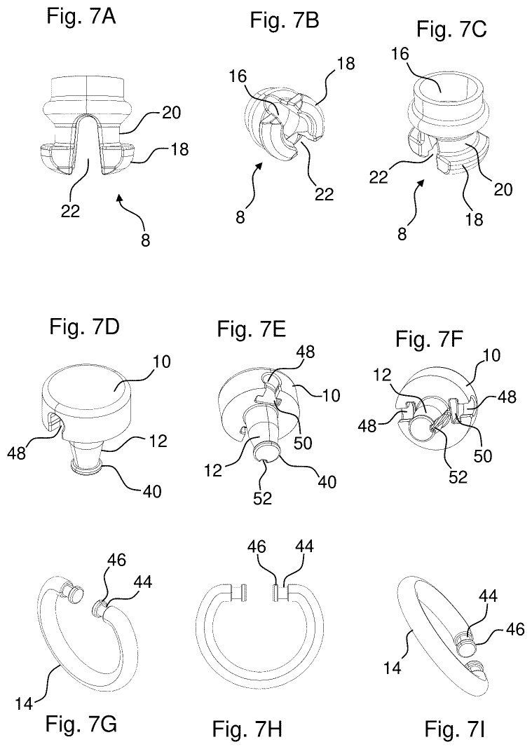

FIG. 7A, FIG. 7B and FIG. 7C illustrate different views of an intermediate member 8 of a pacifier according to an embodiment. The intermediate member 8 comprises a body portion 20 that is separated into two sections by a gap 22. A protrusion 18 is provided in the distal end of each of the sections. A channel 16 is provided in the distal portion of the intermediate member 8. In an embodiment, the intermediate member 8 is made of plastic or another material through injection molding.

FIG. 7D, FIG. 7E and FIG. 7F illustrate different views of a male member 12 of a pacifier according to an embodiment. The male member 12 comprises a conical distal portion. A flanged portion 40 is provided at the distal end of the conical portion. A cylindrical portion is placed adjacent to the distal conical portion. A cap 10 is provided in extension of the proximal portion of the male member 12. The cap 12 is cylindrical, however, two opposite radially extending groove portions 48 are provided in the cap 10.

An insertion track 50 for receiving the end flanges 46 of the handle ring 14 is shown in FIG. 7G, FIG. 7H and FIG. 7I. The end flanges 46 and the thinned portions 44 of the handle ring 14 shown in FIG. 7G, FIG. 7H and FIG. 7I are arranged and configured to engage with the insertion tracks 50 and the groove portions 48 of the handle ring 14. Hereby, the engaging structures constitute rotational joints enabling the handle ring 14 to be rotatably attached to the cap 10. A conduit 52 extends along the length of the male member 12. The conduit 52 is arranged and designed for bringing the inside space of the nipple in fluid communication with the air in the ambient surroundings.

FIG. 7G, FIG. 7H and FIG. 7I illustrate different views of a handle ring 14 of a pacifier according to an embodiment. The handle ring 14 comprises an end flange 46 provided in each end. Moreover, a thinned portion 44 is provided adjacent to each end flange 46. The handle ring 14 comprises an arced section extending along a section of a circle. The end sections of the handle ring 14, however, extend along a single axis of length.

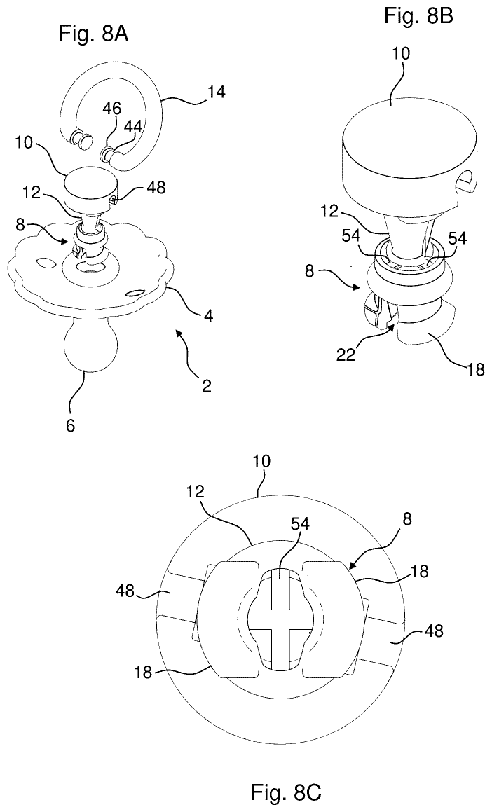

FIG. 8A illustrates a perspective, exploded view of a pacifier 2 according to an embodiment. The pacifier 2, which has not yet been fully assembled, comprises a male member 12 and a cap 10 that are integrated into a single one-piece body. FIG. 8B illustrates a close-up view of this one-piece body.

The pacifier 2 comprises a shield 4 having a shield opening through which a nipple 6 has been inserted. Accordingly, the nipple 6 extends through the shield opening. The nipple comprises a nipple opening provided in a proximal end portion of the nipple 6.

The one-piece body of the pacifier 2 comprises an intermediate member 8 that is configured to be inserted through the nipple opening 24 and through the shield opening. The intermediate member 8 comprises an end portion provided with a channel configured to receive the male portion 12. When the male portion 12 has been inserted through the channel, the male member 12 will engage with the intermediate member 8 and hereby lockingly attach the nipple 6 to the shield 4.

The cap 10 is provided with two opposing grove portions 48 arranged and configured to receive the thinned portions 44 and the end flanges of the handle ring 14.

FIG. 8B illustrates a close-up view of the one-piece structure constituting the male member 12 and the intermediate member 8 shown in FIG. 8A. It can be seen that the male member 12 and the cap 10 are integrated into a single component. The male member 12 and the cap 10 are integrated into a single component.

The distal portion of the male member 12 is attached to the intermediate member 8 by attachment structures 54. In an embodiment, four attachment structures 54 extend between and hereby connect the male member 12 and the intermediate member 8. A different number of attachment structures 54 can be used. In an embodiment, a single attachment structure 54 extends between and hereby connects the male member 12 and the intermediate member 8. In an embodiment, two attachment structures 54 extend between and hereby connect the male member 12 and the intermediate member 8.

In an embodiment, three attachment structures 54 extend between and hereby connect the male member 12 and the intermediate member 8. In an embodiment, more than four attachment structures 54 extend between and hereby connect the male member 12 and the intermediate member 8.

The attachment structures 54 are formed as thin box-shaped structures. The attachment structures 54 can, however, be shaped differently. The intermediate member 8 comprises two spaced apart protrusions 18 separated by a gap 22. The male member 12 is detachably attached to the intermediate member 8 by the attachment structures 54. When assembling the pacifier, the intermediate member 8 is inserted into the nipple opening of a nipple mounted in the shield opening of the shield. Hereafter, the male member 12 is inserted through the channel of the intermediate member 8 by pushing the male member towards the free end of the intermediate member 8. Accordingly, the male member 12 is brought into engagement with the intermediate member 8. Hereby, the nipple is lockingly attached to the shield in the same way as shown in and explained with reference to FIG. 5.

FIG. 8C illustrates an end view of the one-piece structure shown in FIG. 8B. The one-piece structure comprises a male member 12 that is detachably attached to the intermediate member 8 by four attachment structures 54 constituting a cross configuration. It is essential that the attachment structures 54 are arranged and configured to allow the male member 12 to be attached to the intermediate member 8 during storage. The attachment structures 54, however, should be configured to break upon pushing the male member 12 towards the free end of the intermediate member 8 when the intermediate member 8 has been inserted into the nipple opening. Hereby, the one-piece body provides a suitable alternative to the two-piece embodiment shown in FIG. 4B.

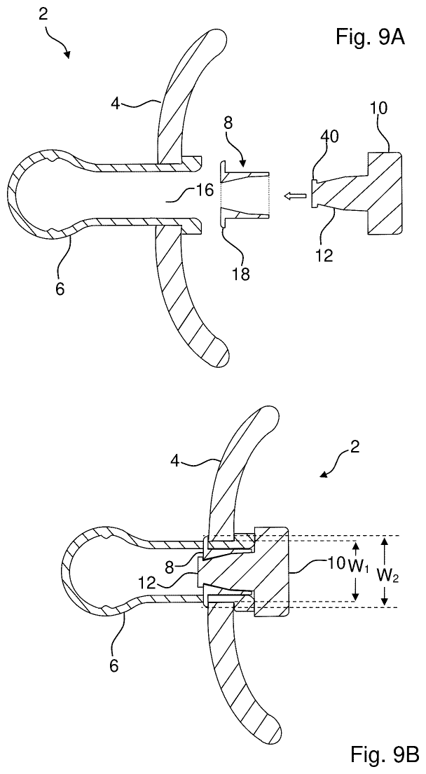

FIG. 9A illustrates an exploded cross-sectional view of a pacifier 2 according to an embodiment. The pacifier 2 comprises a shield 4 provided with a shield opening. A nipple 6 has been inserted through the shield opening. A basically cylindrical intermediate member 8 that is configured to be inserted through the channel is provided in the open end of the nipple 6. A protrusion 18 is provided in the front end of the intermediate member 8. A male member 12 is attached to a cap 10 and constitutes a single component. A flanged portion 40 is provided in the distal end of the male member 12. The flanged portion 40 is designed to provide a locking function when the male member 12 has been inserted through the intermediate member 8 (see FIG. 9B).

FIG. 9B illustrates the pacifier 2 illustrated in FIG. 9A in an assembled state. It can be seen that the nipple 6 has been lockingly attached to the shield 4 by the intermediate member 8 and the male member 12. It can be seen that the width W₂ of the intermediate member 8 is larger than the width W₁ of the shield opening 28 when the male portion 12 has been lockingly inserted into the intermediate member 8.

### LIST OF REFERENCE NUMERALS

2 Pacifier
4 Shield
6 Nipple
8 Intermediate member
10 Cap
12 Male member
14 Ring
16 Channel
18 Protrusion
20 Body portion
22 Gap
24 Nipple opening
26 Proximal end portion
28 Shield opening
30 Support surface
32 Protruding structure
34 Flange
36 Recessed portion
38 Indentation
40 Flanged portion
42, 42′ Hole
44 Thinned portion
46 End flange
48 Grove portion
50 Insertion track
52 Conduit
54 Attachment structure
W₁ Width
W₂ Width

What is claimed is:

1. A pacifier comprising:
a male member;
a shield having a shield opening having a width (W₁);
a nipple extending through the shield opening and having a nipple opening provided in a proximal end portion;
wherein the male member extends through the nipple opening and through the shield opening;
wherein the pacifier comprises an intermediate member extending through the shield opening, wherein the intermediate member comprises a channel, through which channel the male portion extends and engages with the intermediate member and hereby lockingly attaches the nipple to the shield, wherein a width (W₂) of the intermediate member is larger than the width (W₁) of the shield opening.

2. The pacifier according to claim 1, wherein the intermediate member comprises two spaced apart sections separated by a gap.

3. The pacifier according to claim 1, wherein the intermediate member comprises a cylindrical proximal end portion and a body portion extending therefrom.

4. The pacifier according to claim 1, wherein a protruding structure having a support surface is provided in the shield opening, wherein the protruding structure is arranged and configured to engage with the nipple and protrusion structures of the intermediate member.

5. The pacifier according to claim 1, wherein the male member comprises a conical distal portion onto which a flanged portion is provided.

6. The pacifier according to claim 5, wherein an indentation is provided in protrusions of the intermediate member, wherein the flanged portion lockingly engages with the indentation.

7. The pacifier according to claim 1, wherein the male member comprises a proximal cylindrical portion that is attached to a cap.

8. The pacifier according to claim 7, wherein a handle ring is rotatably attached to the cap.

9. The pacifier according to claim 1, wherein the nipple comprises a flange provided in the proximal end portion.

10. The pacifier according to claim 1, wherein the nipple is made of silicone.

11. A method for manufacturing a pacifier comprising a male member, a shield having a shield opening, and a nipple extending through the shield opening and having a nipple opening provided in a proximal end portion, the method comprising:
lockingly inserting the male member through the nipple opening and the shield opening;
inserting the nipple through the shield opening;
inserting an intermediate member through the nipple opening and through the shield opening; and
inserting the male portion through a channel of the intermediate member such that the male portion extends through and engages with the intermediate member, thereby lockingly attaching the nipple to the shield.

12. The method according to claim 11, wherein the intermediate member comprises an end portion provided with a channel.

13. The method according to claim 11, wherein the intermediate member comprises two spaced apart sections separated by a gap.

14. The method according to claim 11, wherein the intermediate member comprises a cylindrical proximal end portion and a body portion extending therefrom.

15. The method according to claim 14, wherein the intermediate member comprises protrusions protruding radially from the body portion, wherein the protrusions are arranged and configured to lockingly engage with the shield opening hereby preventing the intermediate member from being retracted from the shield opening.

16. The method according to claim 11, wherein a protruding structure having a support surface is provided in the shield opening, wherein the protruding structure is arranged and configured to engage with the nipple and protrusion structures of an intermediate member.

17. The method according to claim 11, wherein the male member comprises a conical distal portion onto which a flanged portion is provided.

18. The method according to claim 17, wherein an indentation is provided in protrusions of the intermediate member, wherein the flanged portion lockingly engages with the indentation.

19. The method according to claim 11, wherein the male member comprises a proximal cylindrical portion that is attached to a cap.
